(19) United States
(12) Patent Application Publication
(10) Pub. No.: US 2005/0129394 A1
(43) Pub. Date: Jun. 16, 2005

(54) Cleaning apparatus for camera

(75) Inventor: Tsutomu Ichikawa, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/005,721

(22) Filed: Dec. 7, 2004

(30) Foreign Application Priority Data
Dec. 16, 2003 (JP) 2003-417733

(51) Int. Cl. G03B 17/48

(52) U.S. Cl. 396/429

(57) ABSTRACT

A cleaning apparatus detachable from an interchangeable lens type camera and having a mounting portion which engages with a lens mounting portion of the interchangeable lens type camera. The cleaning apparatus includes a cleaning mechanism which removes dust adhering on an imaging surface of the camera, and a moving mechanism which moves the cleaning mechanism between a cleaning position and a retracted position. In cleaning position, the cleaning mechanism is located close to the imaging surface. In the retracted position, the cleaning mechanism is moved away and retracted from the imaging surface.

This application is based on Japanese Patent Application No. 2003-417733 filed in Japan on Dec. 16, 2003, the entire content of which is hereby incorporated by reference.

### BACKGROUND OF THE INVENTION

1. Field of the Invention

The present invention relates to a cleaning apparatus for a camera, and more particularly to a cleaning apparatus for removing dust, dirt, and other fine foreign particles (hereinafter collectively referred to as “dust”) adhering on an imaging surface in an interchangeable lens type camera.

2. Description of the Related Art

Some imaging apparatuses, such as digital cameras, silver halide film cameras, and video cameras, come equipped with interchangeable lens systems that allow the changing of lenses ranging from wide angle to telephoto according to the purpose of shooting. Here, in particular, in the case of a camera equipped with an imaging device, if dust adheres to the imaging surface of the imaging device, the adhering dust shows up as grainy noise. Since the dust, once made to adhere to the imaging surface, does not easily come off the imaging surface, the grainy noise always appears on images captured thereafter. Further, in the case of an interchangeable lens type camera equipped with an imaging device, the chance of dust entering the camera body and adhering to the imaging surface further increases when changing the lens; accordingly, it has been strongly desired to provide an apparatus that can remove dust in a simple and reliable manner.

As an apparatus for removing dust adhering to the imaging surface, the prior art proposes, for example, an apparatus that blows the dust off the imaging surface by blowing an air stream onto it.

In this cleaning apparatus, a CCD unit comprising a protective glass, a filter, and an imaging device arranged one behind another in the stated order as seen from the front side is built into a cleaning case. This cleaning case has an air stream entrance at one end and an air stream exit at the other hand, and is fixed in place inside the camera body. Clean air is introduced through the air stream entrance, and is vented through the air stream exit after passing over the surface of the protective glass of the CCD unit. At this time, the dust adhering on the protective glass is removed by being carried to the outside together with the clean air.

In the above cleaning apparatus, since an inlet passage and an outlet passage, to be connected to the air stream entrance and the air stream exit, respectively, of the cleaning case, have to be provided in the camera body in order to flow the air into and out of the cleaning case, the apparatus becomes very large in size. Further, the cleaning case is permanently built into the camera body. Therefore, there has been the problem that not only does the available space in the camera body become smaller because the cleaning case occupies the interior space of the camera body, but also the thickness of the camera body increases. There has also been the problem that the weight of the cleaning case adds to the weight of the camera as a whole.

### SUMMARY OF THE INVENTION

A primary object of the present invention is to provide a compact cleaning apparatus for a camera, that is attached only when dust removal is needed and detached when not needed.

Another object of the invention is to provide a compact cleaning apparatus for a camera, that is attachable to and detachable from the mount of the camera, just like an interchangeable lens, and that can be attached only when dust removal is needed.

The above objects of the invention are achieved by providing a cleaning apparatus attachable to and detachable from an interchangeable lens type camera, and comprising: a mounting portion which engages with a lens mounting portion of the interchangeable lens type camera; and a cleaning mechanism which removes dust adhering on an imaging surface of the camera.

The above objects of the invention are also achieved by providing a cleaning apparatus attachable to and detachable from an interchangeable lens type camera, and comprising: a mounting portion which engages with a lens mounting portion of the interchangeable lens type camera; a cleaning mechanism which removes dust adhering on an imaging surface of the camera; and a moving mechanism which moves the cleaning mechanism between a cleaning position, where the cleaning mechanism is positioned close to the imaging surface, and a retracted position, where the cleaning mechanism is retracted by being moved away from the imaging surface.

These and other objects, advantages and features of the invention will become apparent from the following description thereof taken in conjunction with the accompanying drawings, which illustrate specific embodiments of the invention.

### BRIEF DESCRIPTION OF THE DRAWINGS

These and other objects, advantages and features of the invention will become apparent from the following description thereof taken in conjunction with the accompanying drawings in which:

FIG. 1 is a block diagram showing a camera mounted with a cleaning apparatus according to the present invention.

FIG. 2 is a cross sectional view of the camera mounted with the cleaning apparatus according to a first embodiment of the present invention, showing the condition in which a suction nozzle is in its retracted position.

FIG. 3 is a cross sectional view of the camera mounted with the cleaning apparatus according to the first embodiment of the present invention, showing the condition in which the suction nozzle is in its cleaning position.

FIG. 4 is a diagram showing the cleaning apparatus according to the first embodiment of the present invention, as viewed from the camera body side.

FIG. 5 is a cross sectional view showing a cleaning apparatus according to a second embodiment of the present invention.

FIG. 6 is a diagram for explaining a modified example of a suction device in the cleaning apparatus according to the second embodiment of the present invention.

FIG. 7 is a diagram for explaining a modified example of a hermetic contact member in the cleaning apparatus according to the second embodiment of the present invention.

FIG. 8 is a diagram for explaining another modified example of the hermetic contact member in the cleaning apparatus according to the second embodiment of the present invention.

FIG. 9 is a cross sectional view showing a cleaning apparatus according to a third embodiment of the present invention.

FIG. 10 is a cross sectional view of the camera mounted with a cleaning apparatus according to a fourth embodiment of the present invention, showing the condition in which a cleaning pad is in its retracted position.

FIG. 11 is a cross sectional view of the camera mounted with the cleaning apparatus according to the fourth embodiment of the present invention, showing the condition in which the suction nozzle is in its cleaning position.

FIG. 12 is a flow chart for explaining the cleaning operation of the camera cleaning apparatus according to the first, second, and fourth embodiments of the present invention.

FIG. 13 is a flow chart for explaining the cleaning operation of the camera cleaning apparatus according to the third embodiment of the present invention.

### DESCRIPTION OF THE PREFERRED EMBODIMENTS

Embodiments of a cleaning apparatus according to the present invention will be described below with reference to the accompanying drawings. The embodiments herein will be described for the case of an interchangeable lens type digital camera, but it will be recognized that the camera cleaning apparatus of the present invention is also applicable to an interchangeable lens type silver halide film camera or video camera.

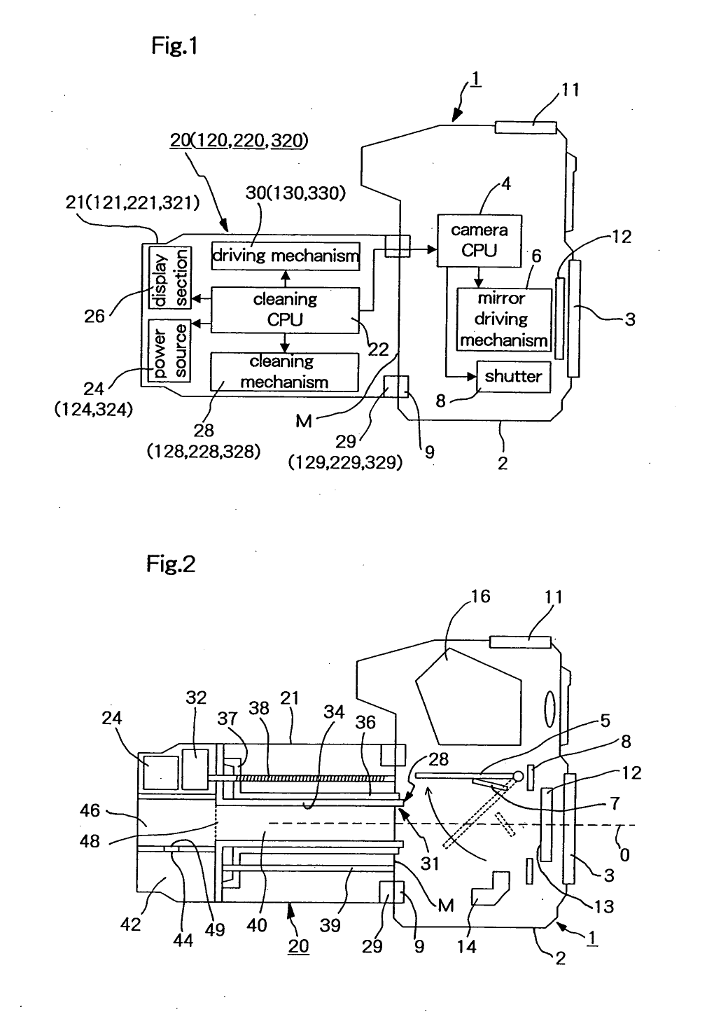

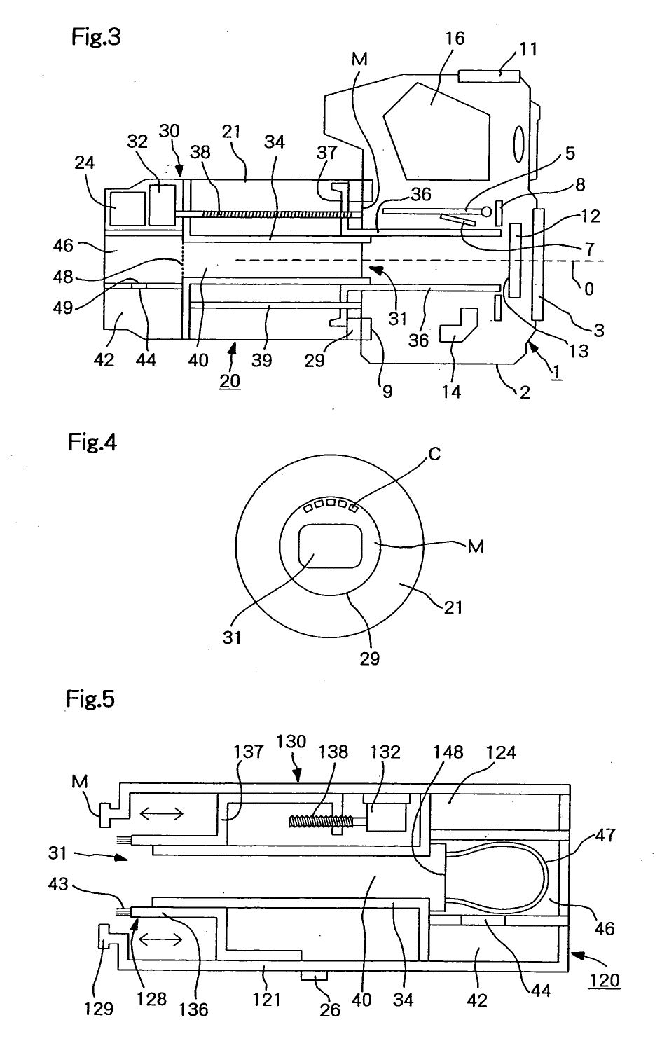

FIG. 1 is a block diagram showing a digital camera 1 to which a cleaning apparatus 20 according to the first embodiment of the present invention is attached by detaching the interchangeable lens. FIG. 2 is a cross sectional view of the digital camera 1 mounted with the cleaning apparatus 20 according to the first embodiment of the present invention; in FIG. 2, a suction nozzle 36 is in its retracted position. FIG. 3 is a cross sectional view of the digital camera 1 when the suction nozzle 36 shown in FIG. 2 is set in its cleaning position. FIG. 4 is a diagram showing the cleaning apparatus 20 as viewed from the camera body 2 side.

The interchangeable lens type digital camera 1 is constructed so that the interchangeable lens or the cleaning apparatus 20 can be readily attached to and detached from the camera body 2.

As shown in FIG. 1, the camera body 2 comprises: a camera CPU 4 for controlling the entire camera; a mirror driving mechanism 6 for driving a main mirror 5 and a sub mirror 7 (FIG. 2); a shutter 8; a charge coupled device (CCD) 12; and a body side mount 9 to which the cleaning apparatus 20 is to be attached. The camera body 2 further comprises: an operation section 11 for selecting shooting mode, playback mode, display mode, cleaning mode, etc.; a display section 3 for displaying various kinds of information for the camera 1; a phase difference AF module 14 (FIG. 2) for detecting the focused condition by using reflected light from the sub mirror 7; and a pentaprism 16 (FIG. 2) for directing reflected light from the main mirror 5 into an eye piece.

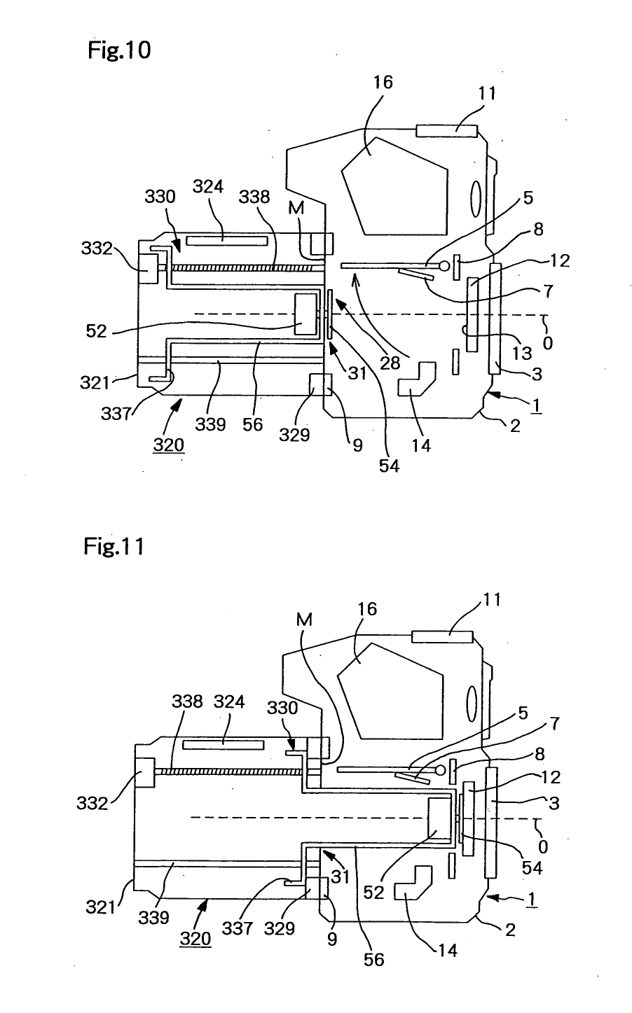

As shown in FIG. 2, the main mirror 5 is a half silvered mirror, which reflects a portion of subject light and transmits the remaining portion of the subject light. The sub mirror 7 is disposed underneath the main mirror 5. The main mirror 5 and the sub mirror 7 are mounted so as to be swingable between the measuring position indicated by dashed lines and the shooting position indicated by solid lines. In the measuring position, the main mirror 5 is tilted at an angle of 45 degrees relative to a shooting light axis 0, and reflects a portion of the subject light into the pentaprism 16. The sub mirror 7 in the measuring position reflects the subject light transmitted through the main mirror 5 and thus directs it into the phase difference AF module 14. The measuring position is set so as to move away from the traveling path of the suction nozzle 36 or a movable cylinder 56 (FIG. 10). In the shooting position, since the main mirror 5 and the sub mirror 7 are moved away from the shooting light path, the subject light is introduced directly onto the imaging device 12. The main mirror 5 and the sub mirror are swingably supported on a swing axis (not shown), so that the main mirror 5 and the sub mirror 7 are moved together in swinging fashion. The main mirror 5 and the sub mirror 7 are constructed so as to be driven in swinging fashion by the mirror driving mechanism 6 which comprises an electric motor, gear, etc. Accordingly, the main mirror 5 and the sub mirror 7 are moved upward by the mirror driving mechanism 6 into the shooting position (mirror up) or pushed downward into the measuring position (mirror down).

The shutter 8 (FIG. 1) is disposed in front of the charged coupled device (CCD) 12 as the imaging device. The shutter 8 is, for example, a focal plane shutter having a front curtain and a rear curtain.

The imaging device 12 is a device for converting subject image light into an electrical signal, and is constructed from a photoelectric converting device such as a charge coupled device (CCD) or a complementary MOS (CMOS) device. Usually, an optical filter and a protective glass are arranged one behind the other on the front side, i.e., the subject side of the photoelectric converting device. In this patent specification, of the photoelectric conversion related components such as the photoelectric converting device, protective glass, optical filter, etc., the exposed surface of the component located at the foremost end on the subject side is generally referred to as the imaging surface 13 (FIG. 2).

As shown in FIG. 2, the mount 9 of the body 2 is a mounting portion for mounting the interchangeable lens or the cleaning apparatus 20 of the present invention, and is formed around its circumference with a groove having a notch (not shown). An engaging protrusion 62 (to be described later) on a mount 29 of the cleaning apparatus 20 engages with the groove (not shown) formed in the mount 9 of the body 2, thus locking one to the other in the so-called bayonet fashion. In this condition, the mount 29 of the cleaning apparatus 20 is held in contact with the mount 9 of the body 2 via a mount surface M.

As shown in FIG. 1, the cleaning apparatus 20 comprises a cleaning CPU 22, a battery (power source) 24, a cleaning mechanism 28, and a driving mechanism 30, which are contained in a cylindrical case 21. A display section 26 is located on the outside surface of the case 21. The mount 29 of the cleaning apparatus 20 is provided at the end of the case 21 that faces the camera body 2.

The cleaning CPU 22 controls the entire operation of the cleaning apparatus 20 in cooperation with the camera CPU 4. The battery (power source) 24 supplies power to the CPU 22, the cleaning mechanism 28, and the driving mechanism 30.

As shown in FIG. 2, the cleaning mechanism 28 comprises, in addition to the cylindrically shaped suction nozzle (cleaning member) 36, a dust collecting chamber 46 which communicates with the suction nozzle 36 and collects dust, a suction window 48 which separates the suction nozzle 36 from the dust collecting chamber 46 and thus prevents backflow of dust, and a suction device 42 which applies a negative pressure. Between the dust collecting chamber 46 and the suction device 42 are disposed a suction port 44 connecting between them and a filter 49 for collecting dust.

The driving mechanism 30 (FIG. 1) comprises: a guide member 34 which guides the movement of the suction nozzle 36 while maintaining airtightness; a flange portion 37 which is connected to the guide member 34 and has a threaded hole; a guide screw 38 which screws into the threaded hole of the flange portion 37; a guide rod 39 which guides the flange portion 37; and a positioning motor 32 which drives the guide screw 38. The rotational driving force of the positioning motor 32, while being reduced in speed via a gear not shown, drives the guide screw 38 for rotation. Then, the rotational driving force of the guide screw 38 is converted into rectilinear motion that causes the suction nozzle 36 to move along the guide member 34. The suction nozzle 36 moves in parallel to the shooting light axis O. As shown in FIG. 3, the suction nozzle 36 when in dust suction operation is set in the cleaning position in which the suction nozzle 36 protrudes from the mount surface M toward the imaging surface 13 of the imaging device 12. When not in operation, the suction nozzle 36 is set in the retracted position in which the suction nozzle 36 is retracted from the mount surface M into the cleaning apparatus 20.

In the dust suction operation, the end of the suction nozzle 36 that faces the camera body 2 is located at the cleaning position where the end stops just short of touching the imaging surface 13. The distance from the mount surface M to the light receiving surface of the CCD (imaging device) 12 is designed and adjusted relative to the mount surface M so that the distance is always the same for all cameras if the cameras are of the same maker. Since the feed amount of the suction nozzle 36 is determined based on these design data, the end of the suction nozzle 36 that faces the camera body 2 does not hit the imaging surface 13 hard. It is also possible to use a light sensor or a ultrasonic sensor to detect how close the end of the suction nozzle 36 on the camera body 2 side is to the imaging surface 13 and to prevent it from hitting the imaging surface 13 by controlling the feed amount.

The suction nozzle 36 is provided with an opening 31 at its end that faces the camera body 2. A suction space 40 is formed inside the suction nozzle 36 and the guide member 34. The interior space of the camera body 2 communicates with the opening 31, the suction space 40, the suction window 48, the dust collecting chamber 46, the filter 49, the suction port 44, and the suction device 42, and these component elements form a continuous suction path for sucking dust therethrough.

As shown in FIG. 4, contacts C as information communicating terminals are provided on the front surface of the mount 29 of the cleaning apparatus. The mount 9 of the body 2 is likewise provided with contacts C as information communicating terminals. When the cleaning apparatus 20 is attached to the camera body 2, the contacts C on both sides are connected. Between the contacts C on both sides, electrical signals are transferred which concern various operations, such as the presence or absence of the attached cleaning apparatus 20, information about the remaining capacity in the battery built into the camera body 2 and the battery 24 of the cleaning apparatus 20, information about the position of the suction nozzle 36, the open/close state of the shutter 8, information about the position of the main mirror 5 or the sub mirror 7, the diving condition of the suction nozzle 36, or the display status of the display section 3 of the body 2 and the display section 26 of the cleaning apparatus 20.

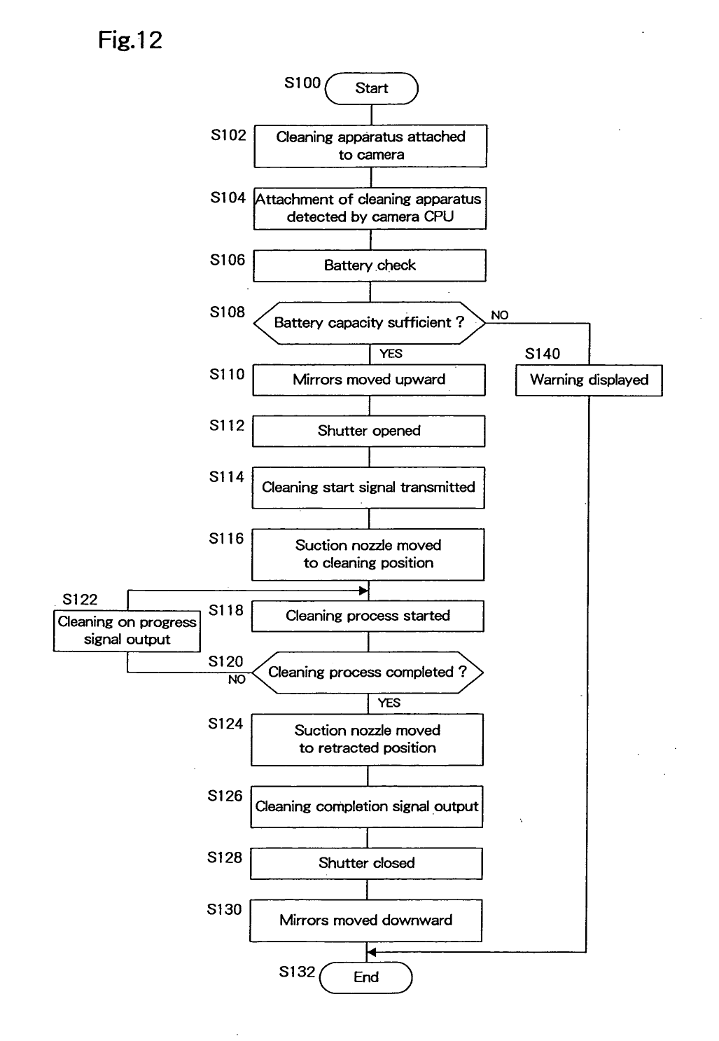

Next, operations of the camera 1 and the cleaning apparatus 20 will be described with reference to FIG. 12.

When the operator changes the mode setting to the cleaning mode by operating the operation section 11 provided on the camera body 2, a series of cleaning operations of the cleaning apparatus 20 is started (step 100). The cleaning apparatus 20 is attached to the camera body 2 by engaging the mount 29 of the cleaning apparatus 20 with the mount 9 of the camera body 2 (step 102). The contacts C on the body side mount 9 are connected to the contacts C on the cleaning apparatus 20, and the camera CPU 4 receives a signal notifying that the cleaning apparatus 20 has been attached to the camera body 2 (step 104).

The camera CPU 4 issues an instruction to check the remaining capacity in the battery built into the camera body 2 and the battery 24 of the cleaning apparatus 20 (step 106). It is checked whether the remaining capacity in each battery is sufficient or not (step 108). If a signal indicating a low battery is received, the camera CPU 4 issues an instruction to display a pictorial warning symbol or a warning message, saying, for example, “BATTERY IS LOW CLEANING CANNOT BE DONE”, at least either on the display section 3 of the body 2 or on the display section 26 of the cleaning apparatus 20 (step 140).

If a signal indicating that the battery's remaining capacity is sufficient is received, the camera CPU 4 issues an instruction to move the main mirror 5 and the sub mirror 7 upward (step 110) and open the shutter 8 (step 112). The mirrors are thus retracted out of the path along which the suction nozzle 36 moves between the cleaning position and the retracted position. The camera CPU 4 sends a cleaning start signal to the cleaning CPU 22 to start the cleaning operation (step 114).

The cleaning CPU 22 issues an instruction to supply power to the positioning motor 32 in the driving mechanism 30 and to drive the positioning motor 32 to rotate the guide screw 38 and thereby move the suction nozzle 36 from the retracted position to the cleaning position (FIG. 3) where the nozzle end stops just short of touching the imaging device 12 (step 116). When suction force is generated by operating the suction device 42, the dust collecting chamber 46, the suction space 40, and the interior space of the camera body 2 are evacuated and the dust adhering to the imaging surface 13 is sucked up, thus starting the cleaning process (step 118).

The cleaning CPU 22 determines whether the cleaning is completed or not by checking whether the cleaning process has been performed for a predetermined time (step 120). If the predetermined time has not yet elapsed from the start of the cleaning process, the cleaning CPU 22 outputs a signal indicating the cleaning in progress, and thus issues an instruction to display a pictorial symbol indicating the cleaning in progress or a message, saying, for example, “CLEANING IS IN PROGRESS”, at least either on the display section 3 of the body 2 or on the display section 26 of the cleaning apparatus 20 (step 122).

When the predetermined time has elapsed from the start of the cleaning process, the cleaning CPU 22 issues an instruction to stop the operation of the suction device 42, thus terminating the cleaning process. The cleaning CPU 22 issues an instruction to supply power to the positioning motor 32 and to drive the positioning motor 32 to rotate in the reverse direction and thereby move the suction nozzle 36 from the cleaning position to the prescribed retracted position (FIG. 2) (step 124). When the suction nozzle 36 has moved to the prescribed retracted position, the cleaning CPU 22 sends to the camera CPU 4 a signal indicating that the cleaning is completed (step 126).

Upon receiving the cleaning completion signal, the camera CPU 4 issues an instruction to close the shutter 8 (step 128) and move the main mirror 5 and the sub mirror 7 downward (step 130). When the shutter 8 is closed, and the main mirror 5 and the sub mirror 7 are moved downward, the series of cleaning operations is terminated (step 132).

A cleaning apparatus 120 for a digital camera 1, according to a second embodiment of the invention, will be described in detail with reference to FIGS. 5 to 8. The basic construction relating to the digital camera 1 is the same as that shown in the foregoing first embodiment, and therefore, the following description focuses on differences from the first embodiment. In the second embodiment, the same component members as those in the first embodiment are designated by the same reference numerals.

The cleaning apparatus 120 according to the second embodiment comprises a cleaning CPU 22, a battery (power source) 124, a cleaning mechanism 128, and a driving mechanism 130, which are contained in a cylindrical case 121. A display section 26 is located on the outside surface of the cylindrical case 121. The mount 129 of the cleaning apparatus 120 is provided at the end of the cylindrical case 121 that faces the camera body 2.

The cleaning CPU controls the entire operation of the cleaning apparatus 120 in cooperation with the camera CPU 4. The battery (power source) 124 supplies power to the cleaning CPU 22, the cleaning mechanism 128, and the driving mechanism 130.

The cleaning mechanism 128 comprises a cylindrically shaped suction nozzle (cleaning member) 136, a dust collecting chamber 46 which communicates with the suction nozzle 136 and collects dust, a suction window 148 which separates the suction nozzle 136 from the dust collecting chamber 46 and thus prevents backflow of dust, a bag-like container 47 which collects dust, and a suction device 42 which applies a negative pressure. Between the dust collecting chamber 46 and the suction device 42 is disposed a suction port 44 connecting between them. A hermetic contact member 43 which maintains airtightness is attached to the suction nozzle 136 at the end thereof that faces the camera body 2.

Various soft members that do not scratch the imaging surface 13 can be used for the hermetic contact member 43. As shown in FIGS. 7 and 8, use can be made, for example, of a silicone cloth such as that often used to wipe lenses, unwoven fabric of super fine acrylic, polyester, or nylon fiber such as that used to wipe glasses, a sponge-like pad, or a brush or the like.

The driving mechanism 130 comprises: a guide member 34 which guides the movement of the suction nozzle 136 while maintaining airtightness; a flange portion 137 which is connected to the guide member 34 and has a threaded hole; a guide screw 138 which screws into the threaded hole of the flange portion 137; and a positioning motor 132 which drives the guide screw 138. The rotational driving force of the positioning motor 132, while being reduced in speed via a gear not shown, drives the guide screw 138 for rotation. Then, the rotational driving force of the guide screw 138 is converted into rectilinear motion that causes the suction nozzle 136 to move along the guide member 34. When in dust suction operation, the suction nozzle 136 is set in the cleaning position in which the suction nozzle 136 protrudes from the mount surface M toward the imaging surface 13 of the imaging device 12. When not in operation, the suction nozzle 136 is set in the retracted position in which the suction nozzle 136 is retracted from the mount surface M into the cleaning apparatus 120.

In the dust suction operation, the hermetic contact member 43 attached to the end of the suction nozzle 136 that faces the camera body 2 is located at the cleaning position where the hermetic contact member 43 lightly touches the imaging surface 13 of the imaging device 12. Since the hermetic contact member 43 is in intimate contact with the imaging surface 13 of the imaging device 12, dust can be collected using a relatively weak suction force. Though the hermetic contact member 43 is made to lightly touch the imaging surface 13, the imaging surface 13 is not scratched because the hermetic contact member 43 is made of a soft material.

The suction nozzle 136 is provided with an opening 31 at its end that faces the camera body 2. A suction space 40 is formed inside the suction nozzle 136 and the guide member 34. The interior space of the camera body 2 communicates with the opening 31, the suction space 40, the suction window 148, the dust collecting container 47, the dust collecting chamber 46, the suction port 44, and the suction device 42, and these component elements form a continuous suction path for sucking dust therethrough.

Contacts C as information communicating terminals are provided on the front surface of the mount 129 of the cleaning apparatus 120. The mount 9 of the body 2 is likewise provided with contacts C as information communicating terminals. When the cleaning apparatus 120 is attached to the camera body 2, the contacts C on both sides are connected. Between the contacts C on both sides, electrical signals are transferred which concern various operations, such as the presence or absence of the attached cleaning apparatus 120, information about the remaining capacity in the battery built into the camera body 2 and the battery 124 of the cleaning apparatus 120, information about the position of the suction nozzle 136, the open/close state of the shutter 8, information about the position of the main mirror 5 or the sub mirror 7, the driving condition of the suction nozzle 136, or the display status of the display section 3 of the body 2 and the display section 26 of the cleaning apparatus 120.

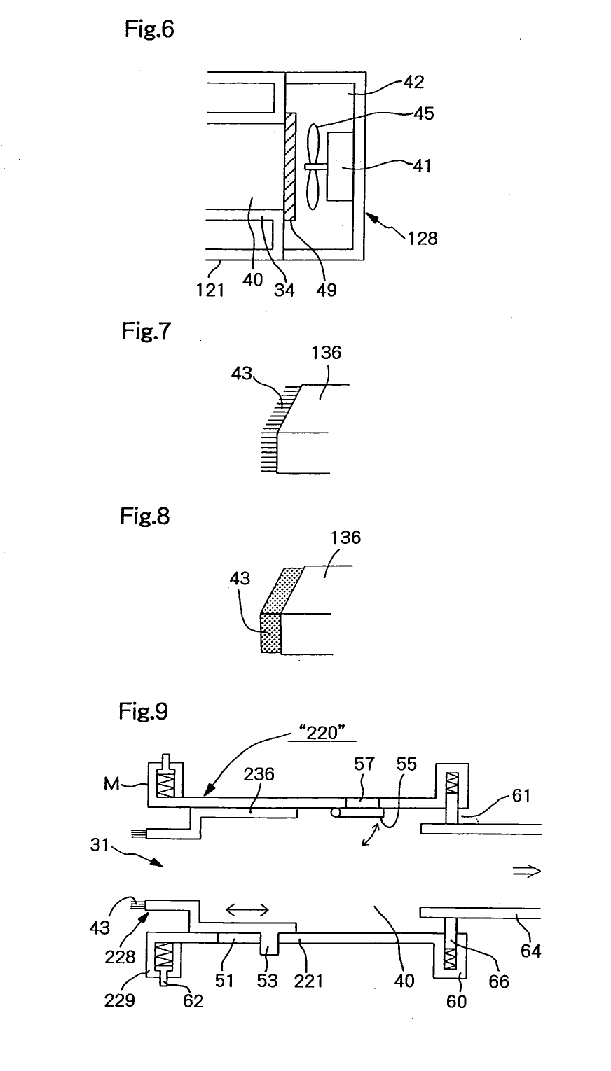

As shown in FIG. 6, the cleaning mechanism 128 can also be constructed by including in the suction device 42 a filter 49 for collecting dust and a fan 45 which is driven by a motor 41. With this simple structure, dust can be effectively sucked by applying a negative pressure to the suction space 40 which extends all the way to the imaging device 12.

The operations of the camera 1 and the cleaning apparatus 120 in the second embodiment are the same as those described in the first embodiment, and therefore, the description will not be repeated here.

A cleaning apparatus 220 for a digital camera 1, according to a third embodiment of the invention, will be described in detail with reference to FIG. 9. The basic construction relating to the digital camera 1 is the same as that shown in the previously described first embodiment, and therefore, the following description focuses on differences from the first embodiment. In the third embodiment, the same component members as those in the first or second embodiment are designated by the same reference numerals.

The cleaning apparatus 220 according to the third embodiment is constructed so that the suction nozzle 236 is moved manually, and the suction device is external to the cleaning apparatus 220.

The cleaning apparatus 220 includes a substantially cylindrically shaped case 221 having a mount 229. The mount 229 of the cleaning apparatus 220 has an engaging protrusion 62 which is biased by a spring or the like outwardly in a radial direction. The engaging protrusion 62 is fitted in bayonet fashion into the groove (not shown) formed in the mount 9 of the body 2. A contact C as an information communicating terminal for notifying the camera CPU 4 of the presence or absence of the attached cleaning apparatus 220 is provided on the end face of the mount 229 of the cleaning apparatus 220 that faces the camera body 2.

The case 221 has an external nozzle fixing mount 60 at its subject side end. The external nozzle fixing mount 60 has a mounting protrusion 66 which is biased by a spring or the like toward the center. When the external suction nozzle 64 is inserted in an external suction port 61 of the external nozzle fixing mount 60, the external suction nozzle 64 is engaged with the mounting protrusion 66 and is thus held fixed in the external suction port 61.

The case 221 has in its outer surface a guide hole 51 extending in a longitudinal direction. The length of the guide hole 51 is chosen so that, when the suction nozzle 236 is moved toward the imaging device 12 and set in the cleaning position, the hermetic contact member 43 lightly touches the imaging surface 13 of the imaging device 12.

The cylindrically shaped suction nozzle (cleaning member) 236 is constructed so that it can move rectilinearly along the inside wall surface of the case 221. The hermetic contact member 43 made of a soft material, similar to the one described in the second embodiment, is attached to the suction nozzle 236 at the end thereof that faces the camera body 2.

The suction nozzle 236 has an outwardly protruding operation lever 53. The operation lever 53 is inserted through the guide hole 51, and can be moved in sliding fashion along the longitudinal direction. Accordingly, when the operator slides the operation lever 53 toward the camera body 2, the suction nozzle 236 moves toward the cleaning position. Conversely, when the operator slides the operation lever 53 toward the subject side, the suction nozzle 236 moves toward the retracted position.

The suction nozzle 236 is provided with an opening 31 at its end that faces the camera body 2. A suction space 40 is formed in a space inside the suction nozzle 236 and the case 221. The interior space of the camera body 2 communicates with the opening 311 the suction space 40, the interior space of the external suction nozzle 64, and the external suction device not shown, and these component elements form a continuous suction path for sucking dust therethrough.

A vent hole 57 is formed in the outer surface of the case 221. A constant pressure valve 55 is provided on the inside wall surface of the case 221 in such a manner as to close the vent hole 57. That is, the constant pressure valve 55 is provided at an intermediate point in the suction path. A conventional vacuum cleaner, such as one used in a home, is used as the external suction device. If the suction force of the conventional vacuum cleaner is too strong, that is, if a suction force is exerted that is greater than a predetermined suction force, the constant pressure valve 55 is opened to introduce the outside air through the vent hole 57, preventing the pressure inside the suction path from being excessively reduced.

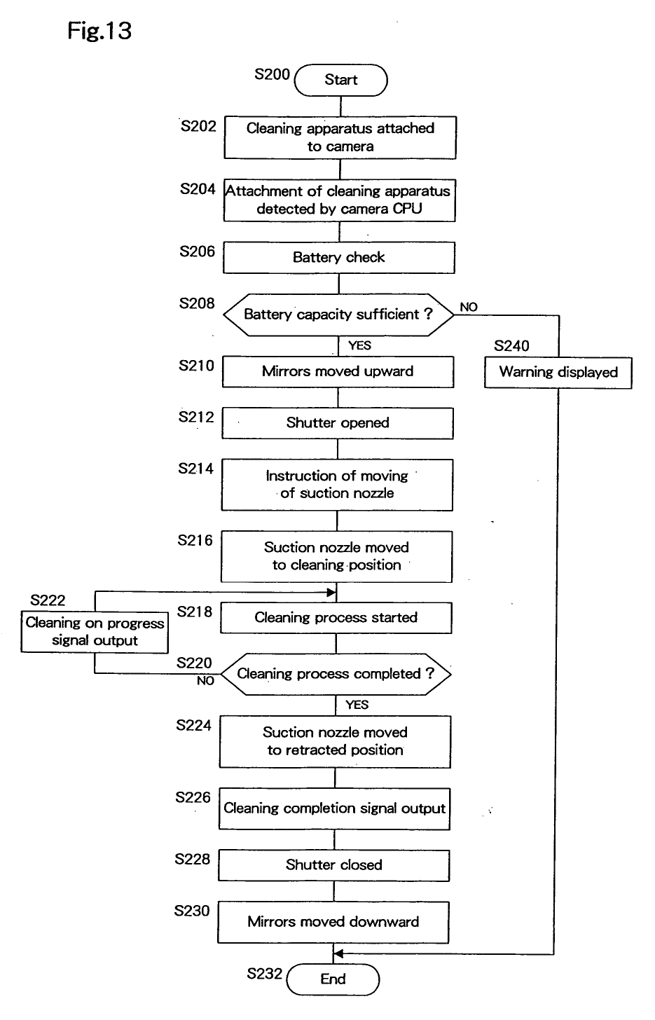

Next, operations of the camera 1 and the cleaning apparatus 120 according to the third embodiment will be described with reference to FIG. 13.

When the operator changes the mode setting to the cleaning mode by operating the operation section 11 provided on the camera body 2, a series of cleaning operations of the cleaning apparatus 220 is started (step 200). The cleaning apparatus 220 is attached to the camera body 2 by engaging the mount 229 of the cleaning apparatus 220 with the mount 9 of the camera body 2 (step 202). The contacts C on the body side mount 9 are connected to the contacts C on the cleaning apparatus 220, and the camera CPU 4 receives a signal notifying that the cleaning apparatus 220 has been attached to the camera body 2.

The camera CPU 4 issues an instruction to check the remaining capacity in the battery built into the camera body 2 and the battery 224 of the cleaning apparatus 220 (step 206). It is checked whether the remaining capacity in each battery is sufficient or not (step 208). If a signal indicating a low battery is received, the camera CPU 4 issues an instruction to display a pictorial warning symbol or a warning message, saying, for example, “BATTERY IS LOW CLEANING CANNOT BE DONE”, at least either on the display section 3 of the body 2 or on the display section 26 of the cleaning apparatus 220 (step 240).

If a signal indicating that the battery's remaining capacity is sufficient is received, the camera CPU 4 issues an instruction to move the main mirror 5 and the sub mirror 7 upward (step 210) and open the shutter 8 (step 212). The mirrors are thus retracted out of the path along which the suction nozzle 236 moves between the cleaning position and the retracted position. The camera CPU 4 issues an instruction to display a pictorial symbol prompting the user to move the suction nozzle 236 to the cleaning position or an instruction message, saying, for example, “MOVE THE CLEANING MEMBER TO THE CLEANING POSITION”, at least either on the display section 3 of the body 2 or on the display section 26 of the cleaning apparatus 220 (step 214).

The user viewing the display moves the suction nozzle 236 to the cleaning position by moving the operation lever 53 of the cleaning apparatus 220 toward the camera body 2 (step 216). When the cleaning CPU 22 receives from a light sensor or the like a signal indicating that the suction nozzle 236 has been moved to the cleaning position, then the dust collecting chamber 46, the suction space 40, and the interior space of the camera body 2 are evacuated and the dust adhering to the imaging surface 13 is sucked up, thus starting the cleaning process (step 218).

The cleaning CPU 22 determines whether the cleaning is completed or not by checking whether the cleaning process has been performed for a predetermined time (step 220). If the predetermined time has not yet elapsed from the start of the cleaning process, the cleaning CPU 22 outputs a signal indicating the cleaning in progress, and thus issues an instruction to display a pictorial symbol indicating the cleaning in progress or a message, saying, for example, “CLEANING IS IN PROGRESS”, at least either on the display section 3 of the body 2 or on the display section 26 of the cleaning apparatus 20 (step 222).

When the predetermined time has elapsed from the start of the cleaning process, the cleaning CPU 22 issues an instruction to stop the operation of the suction device 42, thus stopping the operation of the suction device 42, and sends a signal indicating that the operation of the suction device 42 has been stopped. Upon receiving the signal indicating that the operation of the suction device 42 has been stopped, the camera CPU 4 issues an instruction to display a pictorial symbol prompting the user to retract the cleaning member or an instruction message, saying, for example, “MOVE THE CLEANING MEMBER TO THE RETRACTED POSITION”, at least either on the display section 3 of the body 2 or on the display section 26 of the cleaning apparatus 220. The user viewing the display moves the suction nozzle 236 to the retracted position by moving the operation lever 53 of the cleaning apparatus 220 toward the subject side (step 224).

When a signal is received from a light sensor or the like indicating that the suction nozzle 236 has been moved to the retracted position, the cleaning CPU 22 sends to the camera CPU 4 a signal indicating that the cleaning is completed (step 226).

Upon receiving the cleaning completion signal, the camera CPU 4 issues an instruction to close the shutter 8 (step 228) and move the main mirror 5 and the sub mirror 7 downward (step 230). When the shutter 8 is closed, and the main mirror 5 and the sub mirror 7 are moved downward, the series of cleaning operations is terminated (step 232).

A cleaning apparatus 320 for a digital camera 1, according to a fourth embodiment of the invention, will be described in detail with reference to FIGS. 10 to 12. The basic construction relating to the digital camera 1 is the same as that shown in the previously described first embodiment, and therefore, the following description focuses on differences from the first embodiment. In the fourth embodiment, the same component members as those in the first, second, or third embodiment are designated by the same reference numerals.

The cleaning apparatus 320 according to the fourth embodiment comprises a cleaning CPU 22 (not shown), a battery (power source) 324, a cleaning mechanism 328, and a driving mechanism 330, which are contained in a cylindrical case 321. A display section 26 (not shown) is located on the outside surface of the cylindrical case 321. The mount 329 of the cleaning apparatus 320 is provided at the end of the cylindrical case 321 that faces the camera body 2.

The cleaning CPU 22 controls the entire operation of the cleaning apparatus 320 in cooperation with the camera CPU 4. The battery (power source) 324 supplies power to the cleaning CPU 22, the cleaning mechanism 328, and the driving mechanism 330.

The cleaning mechanism 328 comprises a soft cleaning pad (cleaning member) 54 and a cleaning motor 52 which drives the cleaning pad 54 for rotation. The cleaning motor 52 is mounted inside the movable cylinder 56 in the end portion thereof that faces the camera body 2.

Various soft members that do not scratch the imaging surface 13 of the imaging device 12 can be used for the soft cleaning pad 54. For example, use can be made of a silicone cloth such as that often used to wipe lenses, unwoven fabric of super fine acrylic, polyester, or nylon fiber such as that used to wipe glasses, a sponge-like pad, or a brush or the like.

The driving mechanism 330 comprises: the movable cylinder 56 to which the cleaning pad 54 is attached; a flange portion 337 which is connected to the movable cylinder 54 and has a threaded hole; a guide screw 338 which screws into the threaded hole of the flange portion 337; a guide rod 339 which guides the flange portion 337; and a positioning motor 332 which drives the guide screw 338. The rotational driving force of the positioning motor 332, while being reduced in speed via a gear not shown, drives the guide screw 338 for rotation. Then, the rotational driving force of the guide screw 338 is converted into rectilinear motion that causes the movable cylinder 56 to move along the guide rod 39. When in dust cleaning operation, the movable cylinder 56 is set in the cleaning position in which the movable cylinder 56 protrudes from the mount surface M toward the imaging device 12. When not in operation, the movable cylinder 56 is set in the retracted position in which the movable cylinder 56 is retracted from the mount surface M into the cleaning apparatus 320.

In the dust suction operation, the cleaning pad 54 attached to the outside of the end of the movable cylinder 56 that faces the camera body 2 is located at the cleaning position where the cleaning pad 54 lightly touches the imaging surface 13 of the imaging device 12. When the cleaning pad 54 is driven for rotation, the dust adhering to the imaging surface 13 is wiped off. Though the cleaning pad 54 is made to lightly touch the imaging surface 13 of the imaging device 12, the imaging surface 13 is not scratched because the cleaning pad 54 is made of a soft material.

Contacts C as information communicating terminals are provided on the front surface of the mount 329 of the cleaning apparatus 320. The mount 9 of the body 2 is likewise provided with contacts C as information communicating terminals. When the cleaning apparatus 320 is attached to the camera body 2, the contacts C on both sides are connected. Between the contacts C on both sides, electrical signals are transferred which concern various operations, such as the presence or absence of the attached cleaning apparatus 320, information about the remaining capacity in the battery built into the camera body 2 and the battery 324 of the cleaning apparatus 320, information about the position of the movable cylinder 56, the open/close state of the shutter 8, information about the position of the main mirror 5 or the sub mirror 7, the driving condition of the movable cylinder 56, or the display status of the display section 3 of the body 2 and the display section 26 of the cleaning apparatus 320.

Next, operations of the camera 1 and the cleaning apparatus 320 according to the fourth embodiment will be described with reference to FIG. 12.

When the operator changes the mode setting to the cleaning mode by operating the operation section 11 provided on the camera body 2, a series of cleaning operations of the cleaning apparatus 320 is started (step 100). The cleaning apparatus 320 is attached to the camera body 2 by engaging the mount 329 of the cleaning apparatus 320 with the mount 9 of the camera body 2 (step 102). The contacts C on the mount 9 of the body 2 are connected to the contacts C on the cleaning apparatus 320, and the camera CPU 4 receives a signal notifying that the cleaning apparatus 320 has been attached to the camera body 2.

The camera CPU 4 issues an instruction to check the remaining capacity in the battery built into the camera body 2 and the battery 324 of the cleaning apparatus 320 (step 106). It is checked whether the remaining capacity in each battery is sufficient or not (step 108). If a signal indicating a low battery is received, the camera CPU 4 issues an instruction to display a pictorial warning symbol or a warning message, saying, for example, “BATTERY IS LOW CLEANING CANNOT BE DONE”, at least either on the display section 3 of the body 2 or on the display section 26 of the cleaning apparatus 320 (step 140).

If a signal indicating that the battery's remaining capacity is sufficient is received, the camera CPU 4 issues an instruction to move the main mirror 5 and the sub mirror 7 upward (step 110) and open the shutter 8 (step 112). The mirrors are thus retracted out of the path along which the movable cylinder 56 moves. The camera CPU 4 sends an instruction to the cleaning CPU 22 to start the cleaning operation (step 114).

The cleaning CPU 22 issues an instruction to supply power to the positioning motor 332 and to drive the positioning motor 332 to rotate the guide screw 338 and thereby move the movable cylinder 56 from the retracted position to the cleaning position where it lightly touches the imaging device 12 (step 116). The cleaning CPU 22 starts the cleaning process, that is, power is supplied to the cleaning motor 52 and the cleaning motor 52 is driven to rotate the cleaning pad 54 which thus operates to wipe out the dust adhering on the imaging surface 13 of the imaging device 12 (step 118).

The cleaning CPU 22 determines whether the cleaning is completed or not by checking whether the cleaning process has been performed for a predetermined time (step 120). If the predetermined time has not yet elapsed from the start of the cleaning process, the cleaning CPU 22 outputs a signal indicating the cleaning in progress, and thus issues an instruction to display a pictorial symbol indicating the cleaning in progress or a message, saying, for example, “CLEANING IS IN PROGRESS”, at least either on the display section 3 of the body 2 or on the display section 26 of the cleaning apparatus 320 (step 122).

When the predetermined time has elapsed from the start of the cleaning process, the cleaning CPU 22 issues an instruction to stop the rotation of the cleaning motor 52, thus terminating the cleaning process. The cleaning CPU 22 issues an instruction to supply power to the positioning motor 332 and to drive the positioning motor 332 to rotate the guide screw 338 in the reverse direction and thereby move the movable cylinder 56 from the cleaning position to the prescribed retracted position (step 124). When the movable cylinder 56 has moved to the prescribed retracted position, the cleaning CPU 22 sends to the camera CPU 4 a signal indicating that the cleaning is completed (step 126).

Upon receiving the cleaning completion signal, the camera CPU 4 issues an instruction to close the shutter 8 (step 128) and move the main mirror 5 and the sub mirror 7 downward (step 130). When the shutter 8 is closed, and the main mirror 5 and the sub mirror 7 are moved downward, the series of cleaning operations is terminated (step 132).

Here, the cleaning pad 54 may be driven by rotating as described above, or may be driven by applying fine vibrations in a known manner. Further, the cleaning apparatus may be constructed by combining the earlier described suction type with the cleaning pad type. While the above description has dealt with a digital camera having an imaging device 12, it will be appreciated that the invention is also applicable for cleaning the imaging surface and its surroundings in a silver halide film camera which does not have such an imaging device 12.

As described above, the camera cleaning apparatus of the present invention can be readily attached to and detached from the camera mount, just like an interchangeable lens, and is attached to the camera body by detaching the interchangeable lens only when dust removal is needed. Further, in the cleaning apparatus attached to the mount of the camera body, the cleaning member is moved by the moving mechanism from the retracted position, where the cleaning member is distanced away from the imaging surface, to the cleaning position, where it is positioned close to the imaging surface, and vice versa. When not used for cleaning, the cleaning member is retracted into the retracted position so that it does not protrude outside the cleaning apparatus; this not only serves to prevent the cleaning member from accidentally hitting the main mirror or the shutter inside the camera body when attaching the cleaning apparatus to the camera body, but also contributes to reducing the size of the cleaning apparatus.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. A cleaning apparatus detachable from an interchangeable lens type camera comprising:
a mounting portion which engages with a lens mounting portion of the interchangeable lens type camera;
a cleaning mechanism which removes dust adhering on an imaging surface of the camera; and
a moving mechanism which moves the cleaning mechanism between a cleaning position and a retracted position, the cleaning mechanism being located close to the imaging surface in said cleaning position and being moved away and retracted from the imaging surface in said retracted position.

2. A cleaning apparatus as claimed in claim 1, wherein said moving mechanism is driven by a motor.

3. A cleaning apparatus as claimed in claim 1, wherein said cleaning mechanism includes a suction nozzle facing the imaging surface of the camera.

4. A cleaning apparatus as claimed in claim 1, wherein said cleaning mechanism includes a soft cleaning member facing the imaging surface of the camera.

5. A cleaning apparatus as claimed in claim 3, wherein a soft hermetic contact member is provided at an end of said suction nozzle.

6. A cleaning apparatus as claimed in claim 3, wherein said suction nozzle is connected to an internal suction device disposed within the cleaning apparatus.

7. A cleaning apparatus as claimed in claim 3, wherein said suction nozzle is connected to an exterior suction device disposed outside of the cleaning apparatus.

8. A cleaning apparatus as claimed in claim 7, wherein a constant pressure valve is provided in a suction path formed between the suction nozzle and said external suction device so as to adjust a pressure in the suction path.

9. An interchangeable lens type camera comprising:
a first mounting portion of a camera body which engages with a mounting portion of an interchangeable lens attached to the camera body; and
a cleaning apparatus including a cleaning mechanism for removing dust adhering on an imaging surface of the camera, said cleaning apparatus having a second mounting portion engaging with said first mounting portion and being detachable from the camera.

10. An interchangeable lens type camera as claimed in claim 9, further comprising:
a moving mechanism which moves a cleaning mechanism of said cleaning apparatus between a cleaning position and a retracted position, said cleaning mechanism being located close to the imaging surface in said cleaning position and being moved away and retracted from the imaging surface in said retracted position.

11. An interchangeable lens type camera as claimed in claim 10, further comprising:
an optical member movable between a measuring position and a shooting position, said optical member directing a portion of subject light to an optical finder in said measuring position and directing subject light to the imaging surface in said shooting position;
a detector which detects that the cleaning apparatus is attached to the camera body; and
a controller which moves said optical member out of the path for movement of the cleaning mechanism while opening a shutter disposed in front of the imaging surface of the camera when said detector detects that the cleaning device is attached to the camera body.

12. An interchangeable lens type camera as claimed in claim 11, wherein said optical member includes a rotatably supported half silvered mirror.

13. An interchangeable lens type camera as claimed in claim 9, further comprising:
a display section provided on at least the camera body,
wherein said controller checks the remaining capacity in a power source of the camera body as well as the remaining capacity of a battery of the cleaning apparatus, and warns on said display section that the cleaning apparatus is not able to operate when the remaining capacity in each of the power source and the battery of the cleaning device is below a predetermined value.

14. An interchangeable lens type camera as claimed in claim 9 wherein an information communicating terminal for communicating an electric signal between the camera body and the cleaning device is provided at each of the first mounting portion and the second mounting portion.

15. An interchangeable lens type camera as claimed in claim 10, wherein said moving mechanism is driven by a motor.

16. An interchangeable lens type camera as claimed in claim 10, wherein said cleaning mechanism includes a suction nozzle facing the imaging surface of the camera.

17. An interchangeable lens type camera as claimed in claim 10, wherein said cleaning mechanism includes a soft cleaning member facing the imaging surface of the camera.

18. An interchangeable lens type camera as claimed in claim 16, wherein said suction nozzle is connected to an internal suction device disposed within the cleaning apparatus.

19. An interchangeable lens type camera as claimed in claim 16, wherein said suction nozzle is connected to an exterior suction device disposed outside of the cleaning apparatus.

20. A cleaning apparatus detachable from an interchangeable lens type camera comprising:
a mounting portion which engages with a lens mounting portion of the interchangeable lens type camera; and
a cleaning mechanism which removes dust adhering on an imaging surface of the camera.
